(19) United States
(12) Patent Application Publication
(10) Pub. No.: US 2006/0246334 A1
(43) Pub. Date: Nov. 2, 2006

(54) Assembly structure for use in the fuel cell and assembly method thereof

(76) Inventor: Ko-Chen Shen, Taipei (TW)

Correspondence Address: G. LINK Co., LTD, 3550 Bell Road, MINOOKA, IL, 60447, US

(21) Appl. No.: 11/114,891

(22) Filed: Apr. 27, 2005

(51) Int. Cl. H01M 8/24; H01M 8/10

(52) U.S. Cl. 429/30; 429/32

(57) ABSTRACT

The present invention discloses an assembly structure for use in the fuel cell, which includes a substrate and membranes. The substrate includes a plurality of jointed marks that are provided on the surface connected to the membranes or includes at least a pair of aligning marks that are provided on the surface. The pair of aligning marks are provided on the diagonal position respectively. Each membrane includes the membrane electrode Assembly, whose form and size are matched and correspond to those of the aligning marks.

### FIELD OF THE INVENTION

The present invention relates to an assembly structure for use in the fuel cell and method thereof, and particularly, to an aligning mechanism provided on the substrate to enable the tooling to conveniently assemble the fuel cell.

### BACKGROUNF OF THE INVENTION

Without considering the manufacture scale of capacity, the manufacturing process of a conventional fuel cell proceeds manually and there is small capacity to manufacture a fuel cell. However with this manufacture mode it is obviously hard to satisfy the exact manufacture needs and guarantee the assembly quality so that it can't be adopted to manufacture fuel cells in a great quantity.

Moreover, considering that the manufacture process that is adopted by industries must meet the following features, (a) automated processes and capable of manufacturing fuel cells in a great quantity; (b) with aid of easy checking system (marks, tooling and so on) or use tooling capable of image indemnifying ability so as to proceed with precise alignment while assembling each component of the fuel cell; (c) substantially decrease manufacture errors caused by humans.

In view of the conventional disadvantages found in the prior arts of the fuel cell and expectation from industries toward the manufacturing technology of the fuel cell, the inventors of the present invention try and improve, and invent an assembly structure for use in the fuel cell and assembly method thereof.

### SUMMARY OF THE INVENTION

The main purpose of the present invention is to provide an assembly structure for use in the fuel cell and assembly method thereof, to provide easy and precise aligning mechanism, and have the tooling easily assembling and manufacturing the fuel cell.

To achieve the above purpose, the present invention provides an assembly structure for use in the fuel cell; the assembly structure includes the substrate and the membranes. The substrate includes a plurality of jointed marks that are provided on the surface connected to the membranes or includes at least a pair of aligning marks that are provided on the surface. The pair of aligning marks are provided on the diagonal position respectively. The membrane includes the membrane electrode assembly, whose form and size are matched and correspond to those of the aligning marks.

### BRIEF DESCRIPTION OF THE DRAWINGS

The above objects and advantages of the present invention will become more apparent with reference to the appended drawings wherein:

FIG. 1 is an elevational view showing the first embodiment of the assembly structure of the fuel cell of the present invention;

FIG. 2 is an exploded diagram showing the first embodiment of the present invention;

FIG. 3 is an elevational view showing the second embodiment of the assembly structure of the fuel cell of the present invention;

FIG. 4 is an exploded diagram showing the second embodiment of the present invention;

FIG. 5A to FIG. 5C are embodiments adopted to show the aligning marks of the present invention;

FIG. 6 is a flowchart showing the first assembly method for use in the structure of the fuel cell of the present invention; and

FIG. 7 is a flowchart showing the second assembly method for use in the structure of the fuel cell of the present invention.

### DETAILED DESCRIPTION OF THE INVENTION

The fuel cell 1 of the present invention is finished by closely connecting the membranes 11 to the substrate 13. It's necessary to first prepare the assembly structure of the fuel cell 1 so as to successfully practice the process. Therefore the present invention is focused on the assembly structure of the membranes 11 and the substrate 13; the other components about assembly of fuel cell such as flow field, fuel storage tank and so on aren't the points of the present invention so they won't be described herein.

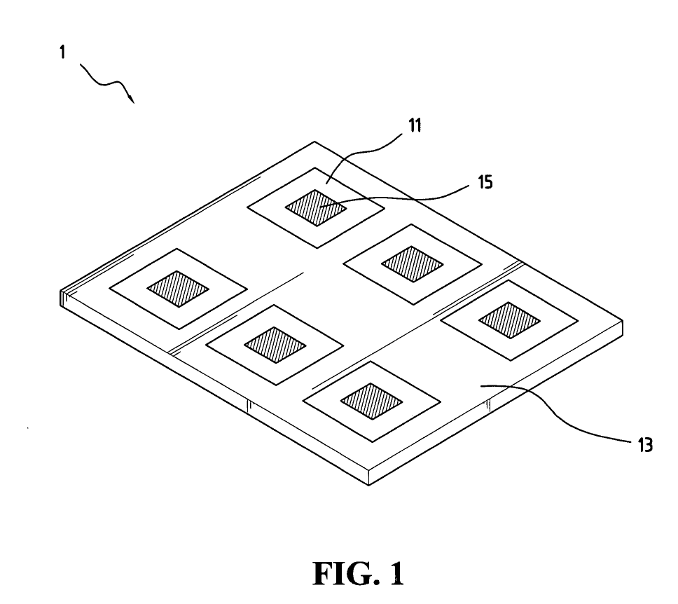

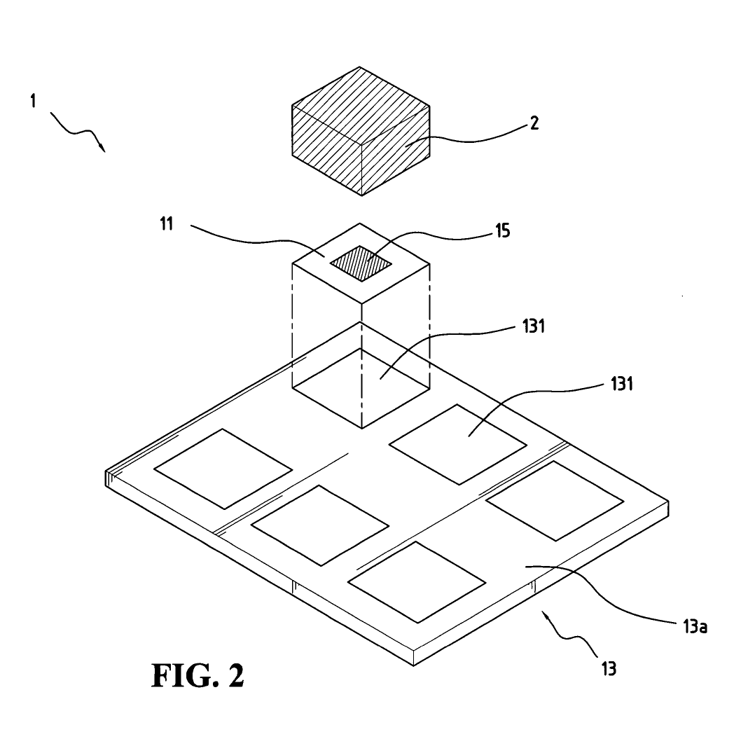

FIG. 1 is an elevational view showing the first embodiment of the assembly structure of the fuel cell of the present invention and FIG. 2 is an exploded diagram showing the first embodiment of the present invention. In FIG. 1, the fuel cell 1 mainly includes the membranes 11 and substrate 13. Each membrane 11 is including a membrane electrode assembly 15, which provides an electrochemical reaction area of the fuel cell 1 so as to produce a current. The surface 13a of the substrate 13 is used to closely connect the membranes 11, providing a plurality of jointed marks 131. What the present invention emphasizes is that the form and size of the membrane 11 are matched and correspond to those of the jointed marks 131 so as to improve the aligning operation of tooling 2 to enable it to precisely proceed with the alignment of membrane 11 to the corresponding jointed mark 131.

In FIG. 2, the tooling 2 absorbs each membrane 11 and moves it to the top position of the substrate 13 that is approximately corresponding to the jointed mark 131. Then, fine tuning the membrane 11 until aligning with the jointed mark 131 and putting it on the corresponding jointed mark 131 of the substrate 13. Repeat that until all jointed marks 131 on the substrate 13 have the membranes 11 being provided thereon. Finally proceeding with the close connection operation for the substrate 13 where membranes 11 are provided thereon so as to enable each membrane 11 to securely attach to the surface 13a of the substrate 13.

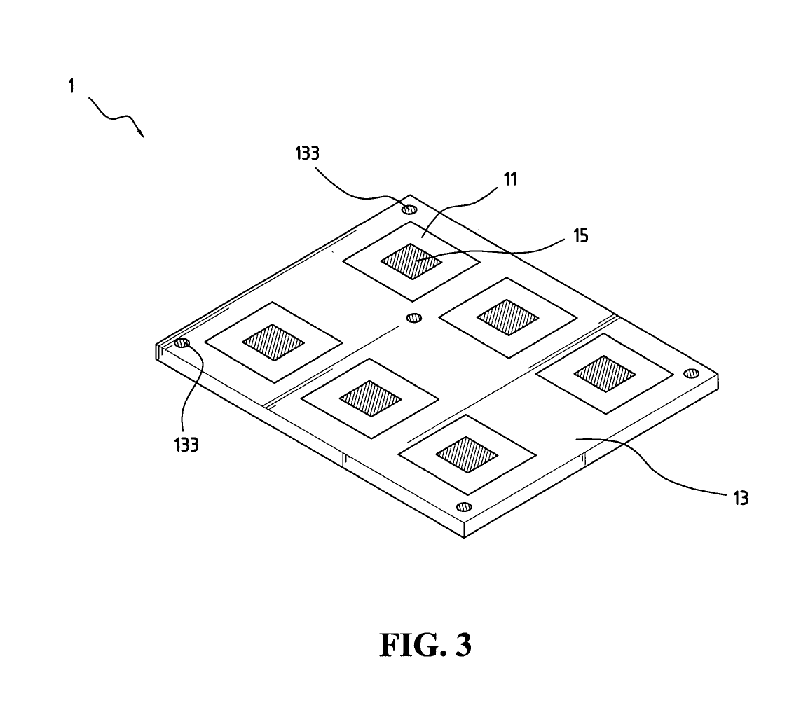

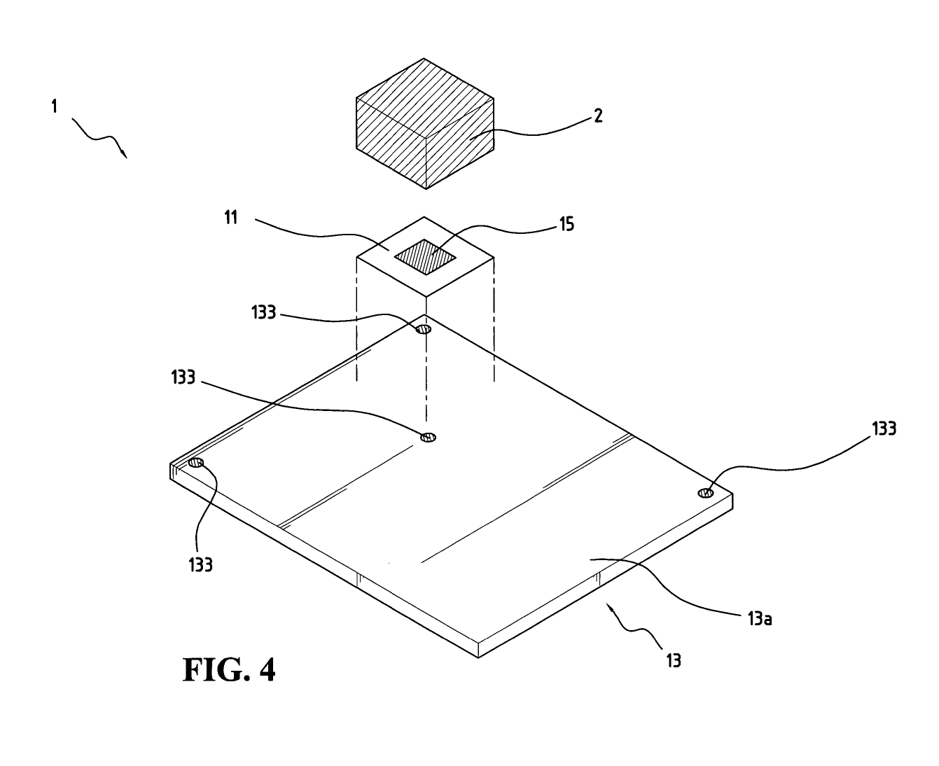

FIG. 3 is an elevational view showing the second embodiment of the assembly structure of the fuel cell of the present invention and FIG. 4 is an exploded diagram showing first embodiment of the present invention. In FIG. 3, the surface 13a on the substrate 13 that is used to closely connect each membrane 11 provides at least a pair of aligning marks 133, and the pair of aligning marks 133 are provided on two ends of the diagonal position so as to enable the tooling 2 to proceed with a correction of the central position of the substrate 13 by the pair of aligning marks 133 to decide the position of the surface 13a where each membrane 11 is provided thereon. What the present invention emphasizes is that the main function of the pair of aligning marks 133 is to provide the reference basis for the tooling 2 to correct the central position of the substrate 13.

In FIG. 4, after the tooling 2 counts the providing position of each membrane 11 according to the pair of aligning marks 133, the tooling 2 absorbs each membrane 11 one by one and moves them to the corresponding decided positions of the surface 13a, then put the membranes 11 on the substrate 13 repeatedly in such way until all membranes 11 are provided. Finally proceeding with the close connection operation of the substrate 13 where the membranes 11 are completely provided so as to enable each membrane 11 to securely attach to the surface 13a of the substrate 13.

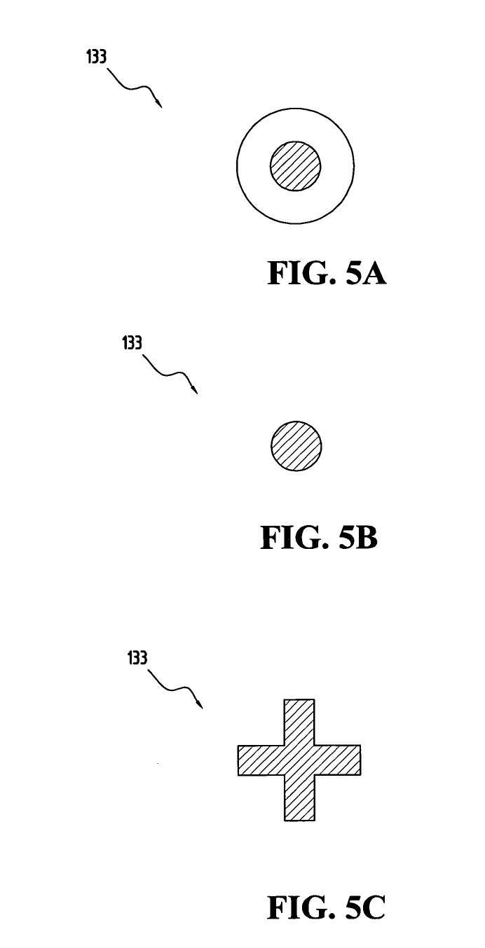

FIG. 5A to FIG. 5C are embodiments adopted to show the aligning marks of the present invention. Any pattern that can be identified by the tooling 2 capable of ability of automatic pattern identification is able to adopt the aligning marks 133.

The substrate 13 of the present invention can be a printed circuit board substrate such as FR4 substrate, flexible printed circuit board and so on. All jointed marks 131 and aligning marks 133 on the surface 13a of the substrate 13 can be formed by screen-printing or print transferring or exposing/developing and so on.

The above jointed marks 131 and the pair of aligning marks 133 can be formed on the surface 13a of one substrate 13 at the same time or in the surface 13a of the substrate 13 by choosing either the jointed marks 131 or the pair of aligning marks 133 according to the actual needs.

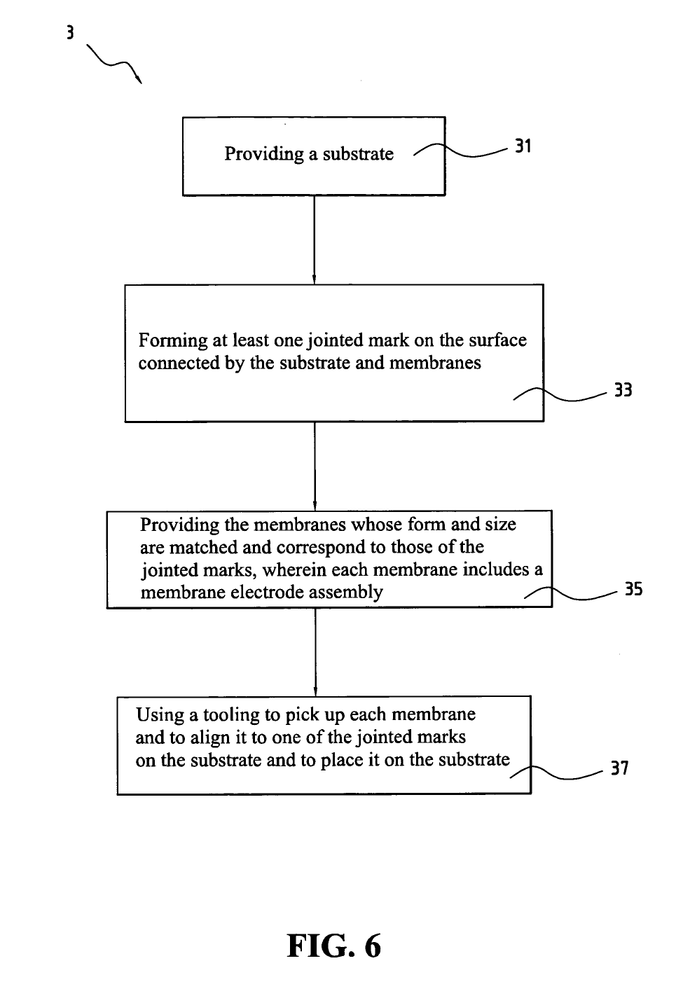

FIG. 6 is a flowchart showing the first assembly method for use in the structure of the fuel cell of the present invention. The first assembly method 3 of the present invention mainly includes step 31, 33, 35 and 37 that will be described as follows. Step 31 is to provide a substrate 13 that can be a printed circuit board substrate. Step 33 is to form a plurality of jointed marks 131 on the surface 13a connected by the substrate 13 and membranes 11. Step 35 is to provide the membranes 11 whose form and size are matched and correspond to those of the jointed marks 131, wherein each membrane 11 includes the membrane electrode assembly 15. The step 33 and 35 can be proceeded respectively mainly to manufacture the assembly structure of the membranes 11 and the substrate 13.

Step 37 is to use the tooling 2 to pick up the membrane 11 and align it to one of the jointed marks 131 of the substrate 13, then put the membrane 11 to said jointed mark 131 of the substrate 13. The pick up method of step 37 can adopt the absorbing method, moreover, the aligning step can proceed with the aligning operation by control of tooling 2 manually or adopt automatic tooling.

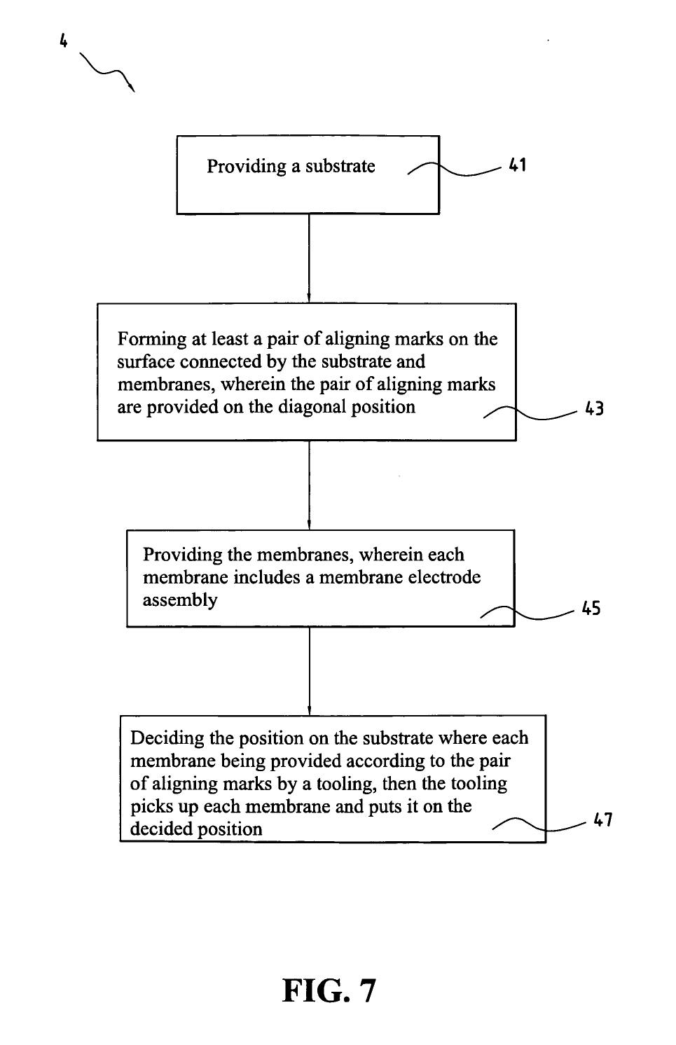

FIG. 7 is a flowchart showing the second assembly method for use in the structure of the fuel cell of the present invention. The second assembly method 4 of the present invention mainly includes step 41, 43, 45 and 47 that will be described as follows. Step 41 is to provide a substrate 13 that can be a printed circuit board substrate. Step 43 is to form at least a pair of aligning marks 133 on the surface 13a connected by the substrate 13 and the membranes 11, wherein the pair of aligning marks 133 are provided respectively in the diagonal position. Step 45 is to provide the membranes 11, wherein each membrane 11 includes a membrane electrode assembly 15. Step 43 and 45 can be proceeded respectively mainly to manufacture the assembly structure of the membranes 11 and the substrate 13.

Step 47 is to decide the position of the substrate 13 where the membrane 11 is provided thereon by using tooling 2 according to the pair of aligning marks 133. The tooling 2 then picks up the membrane 11 and puts it on the decided position.

The assembly structure for use in the fuel cell and assembly method thereof according to the present invention can achieve the following effects:

1. The assembly structure and assembly method according to the present invention enable the tooling to easily proceed with the assembly of the fuel cell by using the indication function of the jointed marks on the substrate or by using the aligning marks to practice the central position correction; and

2. The assembly structure and assembly method according to the present invention can choose manual mode or automatic mode for jointed marks according to the ability of the tooling so as to finish the manufacture of the fuel cell manually or by automation.

It will be apparent to those skilled in the art that various modifications and variations can be made in the computer having liquid crystal display of the present invention without departing from the spirit or scope of the invention. Thus, it is intended that the present invention cover the modifications and variations of this invention provided that they come within the scope of the appended claims and their equivalents.

What is claimed is:

1. An assembly structure for use in the fuel cell comprising:
a substrate, includes a plurality of jointed marks that are provided on the surface connected by the substrate and membranes,
at least one said membrane, wherein each membrane includes a membrane electrode Assembly, the form and size of the membrane are matched and correspond to those of the jointed marks.

2. The assembly structure according to claim 1, wherein said jointed mark can be formed on said surface by printing, print transferring or exposing/developing.

3. The assembly structure according to claim 1, wherein said substrate is a printed circuit board substrate.

4. An assembly structure for use in the fuel cell comprising:
a substrate, includes at least a pair of aligning marks that are provided on the surface connected by the substrate and membranes, wherein the pair of aligning marks are provided on the diagonal position,
at least one said membrane, wherein each membrane includes a membrane electrode assembly being put on the position of the substrate decided according to the pair of the aligning marks.

5. The assembly structure according to claim 4, wherein said jointed mark can be formed on said surface by printing, print transferring or exposing/developing.

6. The assembly structure according to claim 4, wherein said substrate is a printed circuit board substrate.

7. An assembly method for use in the structure of the fuel cell comprising:
(a). providing a substrate,
(b). forming at least one jointed mark on the surface connected by the substrate and membranes,
(c). providing said membranes whose form and size are matched and correspond to those of the jointed marks, wherein said each membrane includes a membrane electrode Assembly,
(d). using a tooling to pick up said each membrane and to align it to one of the jointed marks on the substrate and to place it on the substrate.

8. The assembly method according to claim 7, wherein said jointed mark can be formed on said surface by printing, print transferring or exposing/developing.

9. The assembly method according to claim 7, wherein the aligning of the step (d) is to align by control the tooling manually and to check whether the membrane is aligned to the jointed mark by sight.

10. The assembly method according to claim 7, wherein the aligning of the step (d) is to automatically align by the tooling capable of image identification.

11. The assembly method according to claim 7, wherein said substrate is a printed circuit board substrate.

12. An assembly method for use in the structure of the fuel cell comprising:
(a). providing a substrate,
(b). forming at least a pair of aligning marks on the surface connected by the substrate and membranes, wherein said pair of aligning marks are provided on the diagonal position,
(c). providing said membranes, wherein said each membrane includes a membrane electrode Assembly,
(d). deciding the position on the substrate where said each membrane being provided according to said pair of aligning marks by a tooling, then the tooling picks up said each membrane and puts it on the decided position.

13. The assembly method according to claim 12, wherein said aligning marks can be formed on said surface by printing, print transferring or exposing/developing.

14. The assembly method according to claim 12, wherein said substrate is a printed circuit board substrate.
